(19) United States
(12) Patent Application Publication
(10) Pub. No.: US 2007/0099034 A1
(43) Pub. Date: May 3, 2007

(54) CELL SAFETY COATING

(76) Inventor: Joseph Barrella, Yonkers, NY (US)

Correspondence Address: ISRAEL NISSENBAUM, 1038-56TH ST, BROOKLYN, NY, 11219, US

(21) Appl. No.: 11/532,089

(22) Filed: Sep. 14, 2006

Related U.S. Application Data
(60) Provisional application No. 60/716,833, filed on Sep. 14, 2005.

(51) Int. Cl. H01M 2/00

(52) U.S. Cl. 429/1

(57) ABSTRACT

An electrochemical cell comprising a method and device for the immediate substantial shutdown of electrochemical function under increasing heat build-up therein, said means comprising a thin layer of a PTC (positive temperature coefficient) material substantially completely coated on an electrode surface to substantially and immediately disrupt cell function with concomitant cessation of heat generation at a transition temperature of the PTC material.

### FIELD OF THE INVENTION

This invention relates to safety expedients for primary and secondary electrochemical cells or batteries (hereinafter referred to collectively as “batteries”) and particularly to batteries in which excessive heat generated is a primary hazard.

### BACKGROUND OF THE INVENTION

Electrochemical cells and batteries, particularly those having high energy density lithium components and the like, such as batteries including lithium ion and lithium polymer electrodes have been susceptible to generated excessive heat which can become a runaway condition with possible explosive consequences. Such heat generation may result from the hazards of cell reversal, cell over charge, cell over current charge or discharge, internal or external shorting, manufacturing defects with excess metal particles and the like.

Needless to say, many expedients have been proposed and put into effect in order to effect cell shut down particularly under hazardous condition of runaway generation of heat. The expedients have included fusible or high resistance links in the cell circuit, as well as modification of cell components such as cell separators and admixtures in cell electrodes of high resistance materials to effect disruptions in electron and ion transfer.

Generally, while such expedients have been effective on the whole, they have either been external to the cells of a battery (usually in a battery configuration and container) without effect on internal cell conditions, or, with internal cell placement, have been effective at a rate too slow to halt catastrophic cell failure with runaway cell heat build up and possible explosions.

### SUMMARY OF THE INVENTION

It is therefore an object of the present invention to provide a method and device for modification of cell components, particularly the electrodes in order to effect immediate cell shut down under detrimental high temperature conditions.

It is a further object of the present invention to provide such method and device wherein cell function is not restored until cell or battery temperature has cooled down.

It is yet another object of the present invention to provide a safety method and device whereby there is minimal, if any, disruption of normal cell function.

These and other objects, features and advantages of the present invention will become more evident from the following discussion and drawings in which:

### SHORT DESCRIPTION OF THE DRAWINGS

FIG. 1 is an end exploded view of a typical flat cell configuration with the inclusion of the device of the present invention

FIG. 2 is a perspective view of an electrode of the cell of FIG. 1 with alternative configurations depicted in dotted and dashed lines.

FIG. 3 is a graph showing a typical transition temperature curve of a PTC material relative to increased resistivity.

### DETAILED DESCRIPTION OF THE INVENTION

Generally the present invention comprises a method and device for the immediate shutdown of electrochemical function under increasing heat build-up in electrochemical cells and batteries. These cells specifically include high energy density cells such as lithium ion and lithium polymer cells with cathodes comprised of spinels, manganese dioxide, nickel oxide and the like and depolarizer materials such as sulfer dioxide or thionyl chloride.

In accordance with the present invention a thin layer of a PTC )positive temperature coefficient) material such as a polymer, e.g., polyethylene, loaded with a conductive irradiated carbon, is substantially completely coated on an electrode surface (anode or cathode or both) to substantially and immediately disrupt cell function with concomitant cessation of heat generation at the transition temperature of the PTC material. These PTC materials are well known and they have been used with cells and batteries as safety expedients in the form of the electrode admixture materials to increase the internal resistance of electrodes undergoing heat generation or as part of the external electrical circuit to “unplug” the battery by placing a high resistance in the circuit being used.

An example of a typical conductive PTC material is high-density polyethylene (HDPE; Hizex 5000H, manufactured by Mitsui Petrochemical Industries, Ltd.), which is a crystalline polymer, ethylene-ethylacrylate copolymer (EEA; NVC6170, manufactured by Nippon Unika) and microspherical conductive carbon particles which had been subjected to a silver plating treatment (MSB-10A, manufactured by Nippon Carbon). Typical PTC materials have transition temperatures in the area of about 100° C. which is the approximate temperature at which runaway cell heat generation occurs.

In accordance with the present invention, the electrode materials are placed, as in current practice, on a metal foil substrate such as of aluminum (generally for the cathode), copper (generally for the anode) and generically on the stainless steel, by applications such as slurry or paste application with calendaring or doctoring as applicable, and the like. The PTC material is then substantially fully coated as a layer on one or both sides of the electrode substrate surfaces which face the electrode material across which the electrochemical process with ion transfer occurs. At the transition temperature the PTC layer achieves an almost instant high resistivity thereby instantly substantially completely shutting down cell function. With removal of the electrochemical source of heat generation (i.e., cell high ratedischarge), runaway heat is halted and the cell cools down without further incidence. If the source of the heat generation is removed, and the PTC material is therefore returned to its pre transition state, then the PTC material becomes conductive once more and the cell continues its normal function.

In order to provide the safety function but without introducing detriment to cell performance the PTC layer must be sufficiently which to provide effective impedance increase upon transition yet when not heated, maintain sufficient conductivity to permit normal cell function. Accordingly the PTC layer is from 5 to 25% of the thickness of the electrode upon which it is emplaced and preferably between 10 and 15% of such thickness. The PTC layer preferably covers one surface of the electrode (to minimize normal cell function disruption) but may substantially enclose the electrode. At least 75-80% of the electrode surface should be covered for effective safety shutdown but complete coating of a surface is more amenable to manufacturing processes and is preferred. It is also possible to coat either or boath the anode and cathode of the cell depending upon the intended application requirements.

### DETAILED DESCRIPTION OF THE DRAWINGS

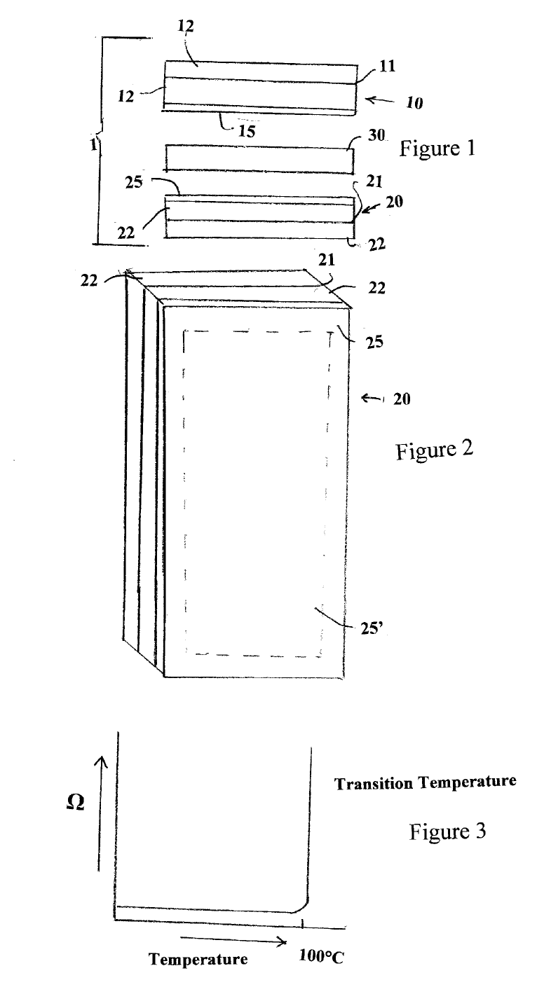

With specific reference to the drawings, FIG. 1 depicts a typical flat cell with anode 10, cathode 20 and separator 30. The anode 10 comprises a lithium ion intercalated layer 12 coated on a copper foil substrate 11. Layer 15 of an irradiated carbon loaded polymeric PTC material is coated completely or substantially (as more clearly seen in FIG. 2) across the entire surface of the anode which faces the cathode 20 and separator 30 and between which there is ionic transfer. Similarly cathode 20 having depolarizer material 22 coated on aluminum substrate 21 has a PTC layer 25 across its surface facing the anode. In addition or alternatively The PTC layer of the anode and/or cathode can be used to effect a separation between the electrode and its connected terminal element (not shown).

In operation, as shown in FIG. 3, the characteristics of the PTC layer material are acutely interdependent with transition temperature. At a specific transition temperature of 100° C. the resistance in ohms of the material spikes abruptly making it ideal for immediate cell safety shutdown

It is understood that the above description and drawings are exemplary of the present invention and that changes in material, configuration and the like may be made without departing from the scope of the present invention as defined in the following claims.

What is claimed is:

1. An electrochemical cell comprising means for the immediate substantial shutdown of electrochemical function under increasing heat build-up thereinsaid means comprising a thin layer of a PTC (positive temperature coefficiant) material substantially completely coated on an electrode surface to substantially and immediately disrupt cell function with concimitant cessation of heat generation at a transition temperature of the PTC material.
